(19) United States
(12) Patent Application Publication
(10) Pub. No.: US 2024/0335802 A1
(43) Pub. Date: Oct. 10, 2024

(54) DOUBLE VENTURI

(71) Applicant: Raycon Industries, Inc., Brea, CA (US)

(72) Inventor: Tak-Yiu Wong, Cerritos, CA (US)

(21) Appl. No.: 18/628,381

(22) Filed: Apr. 5, 2024

Related U.S. Application Data
(60) Provisional application No. 63/458,056, filed on Apr. 7, 2023.

(51) Int. Cl. B01F 25/312

(52) U.S. Cl. CPC B01F 25/3123; B01F 25/3124; B01F 25/31251

(57) ABSTRACT

A double venturi may include an outer venturi and an inner venturi at least partially surrounded by the outer venturi. The double venturi may include an inner venturi inlet, an inner venturi throat, a high pressure inlet port located in the inner venturi inlet and a low pressure inlet port located in the inner venturi throat. The inner venturi and the outer venturi may be coaxial.

### BACKGROUND

### Field

In the context of flow within pipes there is a need to measure the flow rate. Venturis are a device that can be used to measure flow rate or produce a pressure signal output. The Venturi effect is the reduction in fluid pressure that results when a fluid flows through a constricted section (or choke) of a pipe.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of one or more embodiments of the system and methods provide several advantages over traditional systems and methods.

One aspect relates to a venturi, in particular a double venturi. The double venturi may be a part of a system and may be configured to produce or facilitate the production of a pressure signal. The double venturi includes an outer venturi and an inner venturi disposed within the outer venturi. Both the outer venturi and the inner venturi include an inlet, a convergent section, a throat, a divergent section, and an outlet. The total flow through the venturi may be split between the inner venturi and the outer venturi. Both the outer venturi and the inner venturi include a beta ratio. The beta ratio is the ratio of the throat diameter to the inlet diameter. The double venturi includes a high pressure inlet port and a low pressure inlet port connected via a flow tube. The high pressure inlet port and the low pressure inlet port may be located in the inner venturi and may be connected to a high pressure outlet port and a low pressure outlet port located on the outside of the outer venturi.

In some configurations, the inner venturi may be supported within the outer venturi by a plurality of ribs. In some configurations, the ribs include channels which allow each of the high pressure inlet port and the low pressure inlet port to transmit flow to a respective one of the high pressure outlet port and the low pressure outlet port.

In some configurations, the outer venturi and the inner venturi are coaxial.

In some configurations, the beta ratio of the outer venturi may be greater than that of the inner venturi.

In some configurations, the flow tube may include an adjustment valve for mixing the high and low pressure.

### BRIEF DESCRIPTION OF THE DRAWINGS

These and other features, aspects and advantages of the present invention are described herein with reference to drawings of preferred embodiments, which are intended to illustrate, and not to limit, the present invention.

FIG. 1 is a side view of an embodiment of a double venturi.

FIG. 2 is an end view of the double venturi of FIG. 1.

FIG. 3 is a sectional view of the double venturi of FIG. 1 taken along line A-A of FIG. 2.

FIG. 4 is a sectional view of the double venturi of FIG. 1 taken along line B-B of FIG. 2.

FIG. 5 is a partial schematic view of a system incorporating the double venturi of FIG. 1.

### DETAILED DESCRIPTION

Venturis are normally used to measure the speed or velocity of a fluid by measuring the pressure change from one point to another. A venturi can also be used to inject a liquid or a gas into another liquid. A venturi relies on the venturi effect, which is the reduction in fluid pressure that results when a fluid flows through a constricted section (or throat) of a pipe. A venturi includes an inlet and a throat, both having a diameter. The ratio of the throat diameter to the inlet diameter is called the beta ratio. The lower the beta ratio, i.e. the more constricted the throat section, the greater the loss in overall pressure. However, a lower beta ratio also means a greater drop in pressure in the throat, which allows for more accurate measurements and calculations. A standard venturi has a beta ratio between 0.3 and 0.7, which results in a significant loss in pressure. This pressure loss stems from the friction created by the constricted section. This loss in pressure can put an additional load on any pump in the system and compromise the full flow rate coming from the pump. The double venturi is able to obtain accurate inlet and throat flow pressures with a minimal loss in overall pressure or a reduced loss in comparison to a conventional venturi.

The double venturi includes an inner venturi and an outer venturi. The inner venturi is located inside the outer venturi and may be coaxial. The inner venturi is at least partially surrounded by the outer venturi. Flow enters the double venturi and is split, with some flow passing around the inner venturi and through the outer venturi, and the remainder of the flow passing through the inner venturi. In order to calculate parameters such as flow rate, a venturi includes a high pressure inlet port located in the venturi inlet and a low pressure inlet port located in the throat. In this case, the double venturi includes a high pressure inlet port located in the inner venturi inlet and a low pressure inlet port located in the inner venturi throat. The inner venturi can have a lower beta ratio than the outer beta ratio. The result is the inner venturi is able to obtain accurate measurements, and the outer venturi is able to allow flow to pass through with less loss than a conventional venturi. The inner beta ratio, or specifically the inner beta throat, may be tuned or sized to create great enough pressure loss to provide an accurate measurement. The outer beta ratio, or specifically the outer beta throat, may be tuned or sized to create a low pressure only to suck the minor flow through the inner venturi, allowing the remainder of flow to pass through the outer venturi with as little resistance as possible or practical. The double venturi is able to obtain accurate measurements while reducing the overall losses in comparison to a conventional venturi.

The inner venturi is supported by a structure inside the outer venturi. The structure may be or comprise a plurality of ribs. These ribs may be configured to support the inner venturi and pass the flow taken from the high pressure inlet port and the low pressure inlet port from the inner venturi to outside the outer venturi where they can be used or measured. The ribs may allow this transmission through channels or passages located inside the ribs. The high pressure flow from the high pressure inlet port may be transmitted through a channel in the rib to a high pressure outlet port on the outside of the outer venturi. The low pressure flow from the low pressure inlet port may be transmitted through a channel in the rib to a low pressure outlet port on the outside of the outer venturi.

The low pressure flow and the high pressure flow may be used to determine the flow rate. The low pressure flow and the high pressure flow may flow into a flow tube, the flow tube being connected to the high pressure outlet port and the low pressure outlet port.

A venturi, or the double venturi, may be used to measure flow rate or it may be used for other purpose such as the create a specific signal pressure. The signal pressure may be a mix of the high pressure flow and the low pressure flow. The mix of high pressure flow and low pressure flow measured in the flow tube may be controlled by an adjustment valve, the adjustment valve being connected to the flow tube. The pressure gauge that measures the pressure in a portion of the flow tube can be located on the low pressure side of the adjustment valve.

The signal pressure may be tuned to match that of a component downstream or down flow of the venturi, such as a remote receiving tank. Further, the system may include a pressure control valve located upstream or up flow of the venturi. Such a system is able to monitor and control the pressure in the component down flow of the venturi, by monitoring the signal pressure, and using the pressure control valve to make adjustments.

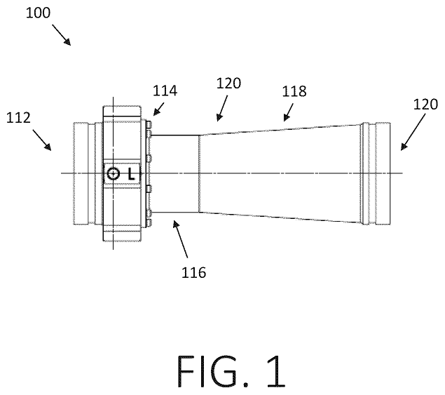

FIG. 1 shows an embodiment of a double venturi 100, comprising an outer venturi 110 and an inner venturi 150. The outer venturi 110 comprises an outer venturi inlet 112 and an outer venturi outlet 120. The fluid flows through the outer venturi inlet 112 and out the outer venturi outlet 120. The outer venturi 110 further includes an outer venturi convergent section 114, an outer venturi throat 116, and an outer venturi divergent section 118. The outer venturi inlet 112 includes an outer venturi inlet diameter 122. The outer venturi throat 116 includes and outer venturi throat diameter 126. The outer venturi inlet diameter 122 and the outer venturi throat diameter 126 define the outer venturi beta ratio. The outer venturi beta ratio is determined by dividing the outer venturi throat diameter 126 by the outer venturi inlet diameter 122.

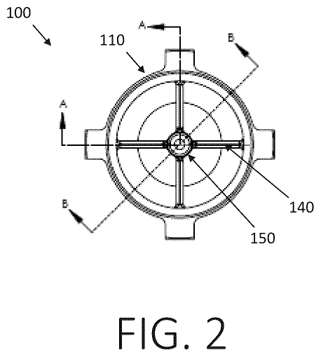

The double venturi 100 may include a plurality of inner ribs 140 which support the inner venturi 150 as shown in FIG. 2. There are four ribs shown in the illustrated embodiment, however there may be more or less. The ribs 140 may be connected to an inner surface of the outer venturi 110 and an outer surface of the inner venturi 150. The ribs 140 may be shaped to support the inner venturi 150 while providing minimal or reduced resistance and/or friction to the fluid while still provide the function of supporting the inner venturi 150 relative to the outer venturi 110. In some configurations, the ribs 140 or the ribs 140 and the inner venturi 150 can be formed as an insert that is received within a conventional venturi and configured to communicate with the low and high pressure channels of the conventional venturi. The combination of a conventional venturi and inner venturi insert can form an overall arrangement that is substantially similar to the double venturi 100 disclosed herein.

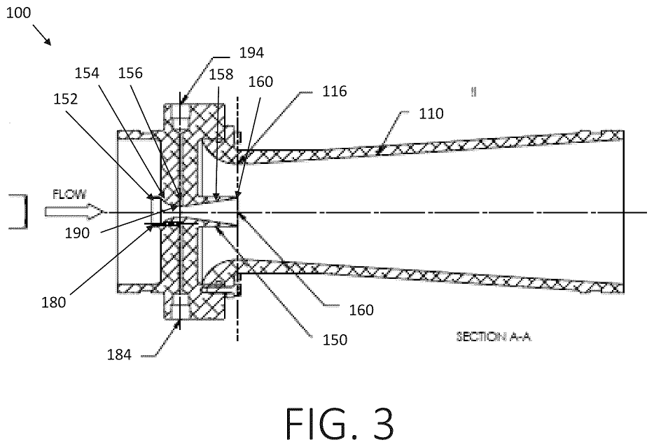

FIG. 3 shows a cross section of a double venturi 100, including a cross section of the ribs 140 supporting the inner venturi 150 within the outer venturi 110. In the illustrated embodiment, the inner venturi 150 and the outer venturi 110 are coaxial. The inner venturi 150 is supported within the outer venturi 110 such that flow can pass around the inner venturi 150 and also through the inner venturi 110. The inner venturi 150 comprises an inner venturi inlet 152 and an inner venturi outlet 160. The inner venturi 150 further includes an inner venturi convergent section 154, an inner venturi throat 156, and an inner venturi divergent section 158. The inner venturi inlet diameter 162 and the inner venturi throat diameter 166 define the inner venturi beta ratio. The inner venturi beta ratio is determined by dividing the inner venturi throat diameter 166 by the inner venturi inlet diameter 162.

The double venturi 100 includes a high pressure inlet port 180 and a low pressure inlet port 190. The high pressure inlet port 180 is located in the inner venturi inlet 152. The low pressure inlet port 190 is located in the inner venturi throat 156. The high pressure inlet port 180 is hydraulically connected by the high pressure channel 182 to the high pressure outlet port 184 located on the outside of the outer venturi 110. The low pressure inlet port 190 is hydraulically connected by the low pressure channel 192 to the low pressure outlet port 194 located on the outside of the outer venturi 110. The high pressure channel 182 and the low pressure channel 192 may be located in individual ribs of the plurality of ribs 140. The high pressure channel 182 and the low pressure channel 192 may be located in the same rib 140 or they may be located in different ribs 140.

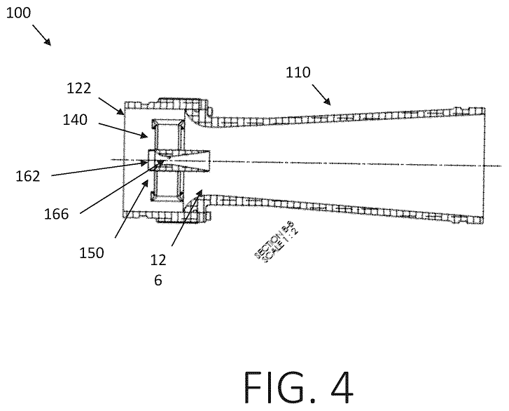

FIG. 4 shows a cross section of the double venturi 100 that does not pass through the ribs 140. The outer venturi beta ratio 128 is greater than the inner venturi beta ratio 168. This allows the double venturi 100 to obtain accurate pressure measurements with the inner venturi 150, while reducing the friction in the system with a higher beta ratio in the outer venturi 110, and thus reducing the overall pressure loss. The outer venturi beta ratio 128 may be equal to or greater than 0.5, or may preferably be between 0.5 and 0.7, but may be between 0.6 and 0.7, or can be about 0.67. The inner beta ratio 168 may be equal to or less than 0.5, or may preferably be between 0.3 and 0.5, but may be between 0.4 and 0.5, or can be about 0.42. The outer beta ratio, or specifically the outer venturi throat 116, may be tuned or sized to create a low pressure only or primarily to suck the minor flow through the inner venturi 150, allowing the remainder of the flow to pass with as little resistance as possible.

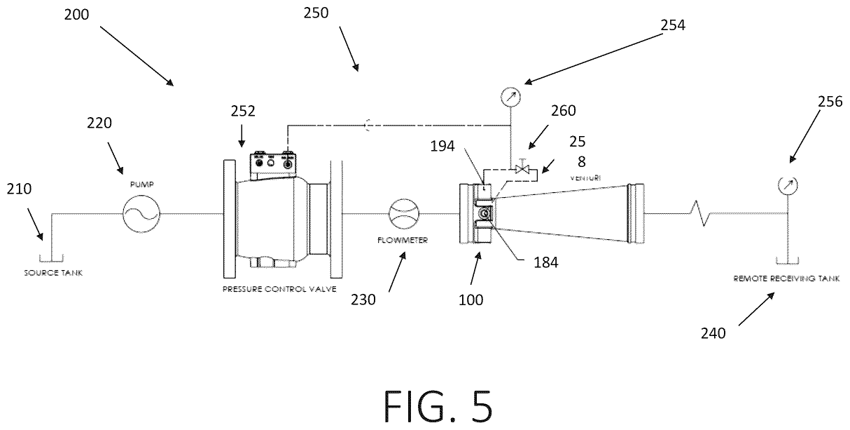

FIG. 5 shows the double venturi 100 in use in a system 200. The system 200 may include a source tank 210, a pump 220, a flow meter 230, a remote receiving tank 240, and a pressure control system 250. The pressure control system 250 may include a pressure control valve 252, a first pressure gauge 254, a second pressure gauge 256 associated with the remote receiving tank 240, a flow tube 258, an adjustment valve 260, and the double venturi 100. The high pressure outlet port 184 and the low pressure outlet port 194 may both be connected to the flow tube 258 such that the high pressure flow and the low pressure flow can be transmitted into the flow tube 258. The adjustment valve 260 may be connected to the flow tube 258 such that it can regulate the pressure in the flow tube 258. Specifically, the adjustment valve 260 may be configured to adjust a pressure on the low pressure side of the adjustment valve 260 such that it is the same as the pressure sensed at a second pressure gauge 256. The pressure on the low pressure side of the flow tube 258 may be sense by the first pressure gauge 254. The pressure in the flow tube 258 on the low pressure side may be considered the signal pressure. The pressure control valve 252 may then regulate the pressure at the second pressure gauge 256 by regulating the pressure at the first pressure gauge 254. The use of the double venturi 100 in this system allows for lower overall losses in pressure losses due to the friction in the venturi in comparison to a system incorporating a conventional venturi, and thus a higher flow rate is maintained in the system 200, allowing the remote receiving tank 240 to be filled more quickly.

It should be understood that the components described in this disclosure may be used outside of fuel systems. The components described may be applicable in the flow of any liquid, fluid, gas, or other matter which can flow.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present hydrant valve has been described in the context of particularly preferred embodiments, the skilled artisan will appreciate, in view of the present disclosure, that certain advantages, features and aspects of the mechanism and overall system may be realized in a variety of other applications, many of which have been noted above. Additionally, it is contemplated that various aspects and features of the invention described can be practiced separately, combined together, or substituted for one another, and that a variety of combination and sub combinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A venturi system, the venturi system comprising:
an outer venturi; and
an inner venturi at least partially surrounded by the outer venturi, the inner venturi comprising:
an inner venturi inlet;
an inner venturi throat;
a high pressure inlet port located in the inner venturi inlet; and
a low pressure inlet port located in the inner venturi throat.

2. The venturi system of claim 1, further comprising a plurality of ribs configured to support the inner venturi relative to the outer venturi, wherein at least one individual rib of the plurality of ribs is connected to an inside surface of the outer venturi and an outside surface of the inner venturi.

3. The venturi system of claim 1, further comprising a high pressure outlet port located on an outside of the outer venturi, wherein the high pressure inlet port is hydraulically connected to the high pressure outlet port.

4. The venturi system of claim 3, wherein the high pressure inlet port is connected to the high pressure outlet port by a high pressure channel located within a rib configured to support the inner venturi relative to the outer venturi.

5. The venturi system of claim 1, further comprising a low pressure outlet port located on an outside of the outer venturi, wherein the low pressure inlet port is hydraulically connected to the low pressure outlet port.

6. The venturi system of claim 5, wherein the low pressure inlet port is connected to the low pressure outlet port by a low pressure channel located within a rib configured to support the inner venturi relative to the outer venturi.

7. The venturi system of claim 1, wherein the inner venturi and the outer venturi are coaxial.

8. The venturi system of claim 1, further comprising an outer beta ratio and an inner beta ratio, wherein the outer beta ratio is greater than the inner beta ratio.

9. The venturi system of claim 1, further comprising an outer beta ratio, wherein the outer beta ratio is between 0.5 and 0.7.

10. A double venturi, the double venturi comprising:
an outer venturi; and
an inner venturi;
wherein the inner venturi and the outer venturi are coaxial.

11. The double venturi of claim 10, wherein the inner venturi comprises a high pressure inlet port.

12. The double venturi of claim 10, wherein the inner venturi comprises a low pressure inlet port.

13. The double venturi of claim 10, further comprising an outer beta ratio and an inner beta ratio, wherein the outer beta ratio is greater than the inner beta ratio.

14. The double venturi of claim 10, further comprising a plurality of ribs configured to support the inner venturi relative to the outer venturi, wherein at least one individual rib of the plurality of ribs is connected to an inside surface of the outer venturi and an outside surface of the inner venturi.

15. The double venturi of claim 14, wherein at least one individual rib of the plurality of ribs comprises a channel located within the individual rib.

16. A method of measuring pressure, the method comprising:
directing a flow into a double venturi;
splitting the flow between an inner venturi and an outer venturi of the double venturi;
generating a controlling pressure signal; and
measuring the controlling pressure signal.

17. The method of claim 16, wherein generating the controlling pressure signal comprises:
directing a high pressure flow and a low pressure flow associated with the inner venturi; and
mixing the high pressure flow and the low pressure flow.

18. The method of claim 16, wherein generating the controlling pressure signal comprises directing a high pressure flow or a low pressure flow from an inlet port in the inner venturi.

19. The method of claim 18, wherein directing the high pressure flow or the low pressure flow from the inlet port in the inner venturi further comprises directing the high pressure flow or the low pressure flow through a channel located in a rib between the outer venturi and the inner venturi.

20. The method of claim 16, further comprising supporting the inner venturi in the outer venturi.
